(19) United States
(12) Patent Application Publication
(10) Pub. No.: US 2023/0222513 A1
(43) Pub. Date: Jul. 13, 2023

(54) RECORDING ETHICS DECISIONS

(71) Applicant: Dell Products L.P., Round Rock, TX (US)

(72) Inventors: Ming Qian, Allston, MA (US); Nicole Reineke, Northborough, MA (US)

(21) Appl. No.: 17/647,529

(22) Filed: Jan. 10, 2022

(51) Int. Cl. G06Q 30/00

(52) U.S. Cl. CPC G06Q 30/018

(57) ABSTRACT

Ethics as a data set interaction variable is disclosed. Ethics are incorporated into the manipulation of data sets. An ethics engine is configured to prompt a user to determine whether manipulations are driven at least in part by ethics. The ethical reasons and ethics labels provided by the user can be recorded in an ethics database. This allows the ethics database to record ethical information and generate recommended manipulations based on ethics.

### FIELD OF THE INVENTION

Embodiments of the present invention generally relate to recording ethics in data generation and consumption. More particularly, at least some embodiments of the invention relate to systems, hardware, software, computer-readable media, and methods for incorporating ethics into data set automation and utilization.

### BACKGROUND

Data scientists often access and use data sets. Whenever a data set is needed by a data scientist (or other user), the data scientist may first search for and identify the data set. For example, the data scientist may search a catalog of data sets. The data scientist can search in many different ways. A search may be performed for a data set that has been used in the past for similar purposes or a data set used by or created by a specific user or organization. The data scientist may also search using key words or other characteristics such as data type.

The reason for acquiring and using a data set often drives the process of selecting a data set from a catalog. The reasons are often amenable to rule-making. As a result, the decisions or reasons for selecting and using data sets are typically rule-driven and/or data type-driven. Selecting a search term is an example of a rule to search for data sets that contain the selected search term.

For example, a data scientist may want a data set whose type is appropriate for test scores. The data scientist may specify rules to search for data sets that contain test scores. Additional rules may be used to focus on specific age groups.

This suggests that, for the purpose of evaluating test scores in the context of demographics, a data scientist will likely want a data set that includes test scores and demographic data. If the data scientist is specifically interested in math test scores, the rules used to identify these may be more refined to exclude data sets that do not contain only math scores. Alternatively, the data scientist may select a data set that includes test scores from multiple subjects. The math test scores can be extracted when the data set is being prepared for use.

Data scientists are able to process the data sets for specific reasons. In this example, the data set may be processed to only consider math test scores from a particular region or geographic area. More generally, the data scientist may perform an action on the data set such as deleting or suppressing test scores that are not math scores. While a rule may be used to exclude non-math test scores, there is no way to understand the reason for excluding non-math test scores. In some instances, the reasons may be practical. In some instances, the reasons may be related to ethics.

In addition to selecting, processing, cleaning, and using data sets for specific purposes based on rules and data types, many data scientists are attempting to incorporate ethics into their decision-making procedures. This is difficult because current decisions are driven by rules and data types rather than ethics. There are no recommendations on how to use and modify data in an ethics-driven manner because that type of correlation or association does not exist. These problems are complicated by the fact that ethics, by nature, are subjective and non-measurable.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of ethics driven decision making;

FIG. 2 discloses aspects of a method for making and/or recording ethics driven decisions in data set utilization;

FIG. 3 discloses additional aspects of ethics related decision making and aspects or recording ethics related decisions;

FIG. 4 discloses aspects of using recorded ethics;

FIG. 5 discloses aspects of a data structure for recording ethics; and

FIG. 6 discloses aspects of a computing device or a computing system.

### DETAILED DESCRIPTION OF SOME EXAMPLE EMBODIMENTS

Embodiments of the present invention generally relate to ethics-driven decisions in data science. More particularly, at least some embodiments of the invention relate to systems, hardware, software, computer-readable media, and methods for recording ethics-driven decision making in selecting, processing, cleaning, and/or utilizing data sets and to performing ethics-based actions when using data sets.

In general, example embodiments of the invention allow ethics to be captured in the context of, by way of example only, data science and data set selection, preparation, and utilization. Embodiments of the invention generate and relate ethics related metadata (e.g., labels or tags) for individuals, organizations, and/or data sets. These labels or tags relate to the manner in which ethics impacted the utilization of a selected data set. The ethic labels or tags may also correspond to actions that can be performed with respect to a data set. By recording ethic decisions or the reasons for making decisions or performing actions, for example by labeling or tagging data sets and/or actions performed on or with respect to data sets, data sets and actions on data sets can be recommended based on ethical considerations, even when ethics may be subjective in nature.

As a user interacts with a data set, the user's actions are recorded. Thus, the manner in which a user searches for a data set, manipulates the data sets, performs actions on the data set, and the like are recorded. These actions can be recorded and associated with the user, an entity, and/or the data set itself. Embodiments of the invention may further prompt the user to determine if the action or other manipulation is motivated by an ethical concern. This allows ethics to be correlated to actions, manipulations, or the like performed on data sets and to users and organizations. This also allows actions or data sets to be recommended on an ethical basis. Further, a user can search/select/manipulate a data set using at least rules, ethics (e.g., ethic-based rules), data types, and the like or combination thereof.

More specifically, an ethics engine can generate recommended or potential actions to be performed based on the ethical labels associated with users, organization, or data sets. Embodiments of the invention include open ended labeling of subjective context and enable the use of complex ideas in suggestions for data set manipulations.

Ethics can be defined in many different ways, but typically relate to shared values. In the context of data science or data set manipulation, ethics may refer, by way of example only, to how the data is collected, how the data is cleaned, planning for situations where non-compliance may occur, or the like. Ethics are further complicated by the fact that some ethics may or may not be shared across users or organizations. In other words, the ethics of one user or entity may differ from the ethics of another user or entity. In addition, different users may regard or prioritize different ethics as more important or more relevant. The ethics of a user may also depend on the current context or use case. The reasons behind performing or not performing an action may be based in personal ethics, organizational ethics, or the like or combination thereof.

When a data set is initially accessed, a copy of the data set may be made available to the requesting user. This allows the user to manipulate or process the data set for a given use case without impacting the original data set. Thus, each user of a particular data set may process or manipulate the data set in a different manner. Manipulations or other actions performed on a data set can vary and may include transforming the data set, cleaning the data set, extracting features from the data set, deleting, or masking certain portions of the data set or the like. Each of these actions, and the ethical reasons thereof, can be recorded. Once recorded, the recorded ethics can be used to facilitate a user's interaction with a data set or with a catalog of data sets.

Embodiments of the invention ensure that multiple aspects of interacting with a data set may be labeled or tagged when the interaction or use has an ethical aspect. A workflow or framework is provided that allows ethical considerations to be recorded at multiple stages of the interaction. Advantageously, these labels benefit subsequent uses of that same data set or the use of other data sets.

In effect, embodiments of the invention provide or relate to a workflow that allows ethical considerations to be used when interacting with data sets and that informs users of ethical driven decisions and/or actions regarding data sets. Embodiments of the invention, by way of example only, collect ethics as a reason that a change, action or decision was made on a data set or a portion thereof, attach, as a label (metadata), the reason for the change, action or decision, record actions and label decisions in a historian that can be used in making recommendations and suggestions across multiple users, use the labels to inform the next user that requests the data set through action informed suggestions and label informed suggestions, and/or use the labels to push and suggest data sets to the same user for different contexts or suggest data sets to different users.

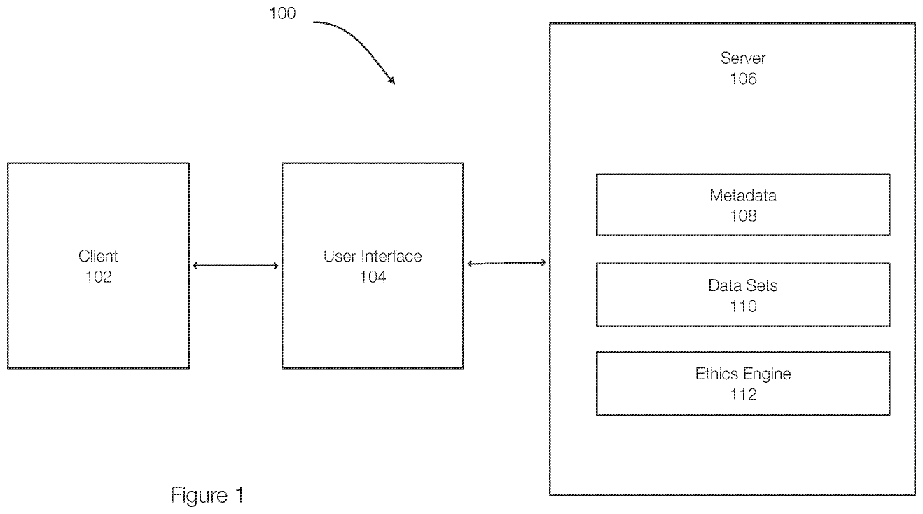

FIG. 1 discloses aspects of an environment for implementing an ethics driven workflow that facilitates recording of ethics and ethics-driven decisions. FIG. 1 illustrates a server 106 that can be accessed by a client 102 over a network. The server 106 is representative of single machine, a server computer, a cluster, an edge system, a datacenter, compute resources, or the like and may include a processor, memory, and other hardware.

The server 106 may store or have access to data sets 110, such as may be used by data scientists. The data sets 110 are associated with metadata 108, which may be stored in a data structure. An ethics engine 112 may perform or facilitate a workflow that allows the client 102 to interact with the server 106, the data sets 110, and/or the metadata 108. The interaction may be achieved via a user interface 104. The client 102 may also represent a device, a system of computers, a network, a datacenter, or the like. Embodiments of the invention are discussed in the context of data sets 110 that are available for use by users such as data scientists. Actions or other interactions performed by a user are performed via the client 102 in these examples. Interactions or actions are generally referred to herein as manipulations. Thus, manipulations may include, but are not limited to, searching for a data set, selecting a data set, performing actions on the data set, or the like or combination thereof.

For example, the user interface 104 allows a user operating the client 102 to browse the data sets 110, select one or more of the data sets 110, act on a selected data set (e.g., copy, clean, move, process, analyze, parse), use a data set, perform an application on the data set, or the like. When a data set is selected, the selected data set may be prepared for use. This may include copying the data set to a different destination, cleaning the data set, or otherwise preparing the selected data set for use by the client 102.

In this example, the metadata 108 includes ethics labels or tags. The metadata 108 is configured, by way of example only, to include information, including ethical information, about users, data sets, organizations, actions performed on data sets, reasons for performing actions, or the like or combination thereof. The metadata 108 may be, in one example, a relational database, or, in another example, the metadata may be recorded or stored in a relational database.

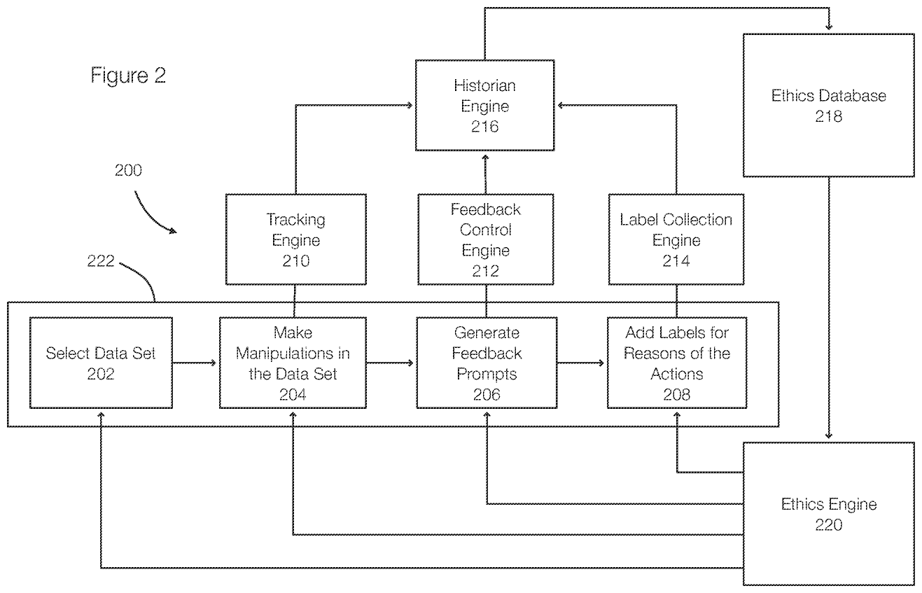

FIG. 2 discloses aspects of an ethics driven process in the context of selecting and using data sets in a computing system and illustrates an example workflow that allows ethical considerations to be used and/or recorded. The framework 200 includes an ethics engine 220, which is an example of the ethics engine 112 in FIG. 1. In FIG. 2, a method 222 may be performed or coordinated by the ethics engine 220. The ethics engine 220 may include different components such as a server component, a client component, a user interface, or the like. These components may operate at different locations and on different devices.

In this example, the ethics engine 220 may include a tracking engine 210, a feedback control engine 212, a label collection engine 214, and a historian engine 216. The ethics engine 220 may interact with the method 222 at different stages. At each of the stages of the method 222, the ethics engine 220 may record into and/or access an ethics database 218, which is an example of the metadata 108. Thus, ethical considerations or actions that have an ethical basis can be recorded in the ethics database 218. The ethics database 218 may also include previously recorded ethical related actions that may be presented to the user as actions, recommendations or other manipulations. Thus, the ethics engine 220 ensures that the method 222 can be performed in a manner that incorporates, considers, and/or recommends ethical reasons and ethical actions.

The method 222 often begins when a data set is selected 202. Selecting a data set may include browsing a catalog or listing of data sets available at a repository, such as may be stored in a datacenter or a data lake. Selecting a data set may also include searching for a data set using different types of search criteria such as size, data type, subject matter, ethics, or the like. Selecting the data set may also include some initialization processes, such as preparing a copy of the data set for consumption.

Once the data set is selected, manipulations 204 may be performed on the data set. Manipulations 204 may include actions such as sorting the data set, deleting specific data, sequencing the data, or the like. The tracking engine 210 tracks the manipulations or other changes made to the data set at this stage. The manipulations 204 can be tracked with respect to the user, an organization and/or the data set. The historian engine 216, which may include or have access to the ethics database 218, stores these manipulations and their relationships to users, organizations, and data sets in the ethics database 218.

Once the manipulations are performed (or before or during), feedback prompts are generated 206 by the feedback control engine 212. The feedback prompts may present the user with a request to provide information related to the manipulations made to or related to the data set. In particular, the feedback control engine 212 may prompt the user to indicate whether the manipulations were performed for ethical reasons. The feedback control engine 212 records any information provided by the user and the historian engine 216 may record the feedback along with the manipulations in the ethics database 218.

The user may be requested to add 208 labels for the manipulations or for the ethical reasons provided by the user. The labels 208 are recorded by the historian engine 216 in the ethics database 218. The ethics engine 220 may prompt for and collect different types of information at each stage of the method 222. This allows ethical relationships between data sets, manipulations on data sets, users, organizations, or the like to be recorded and related in the ethics database 218 and allows these recorded ethics to be used for recommendation purposes.

As a result, in addition to collecting information from the user in the method 222, the ethics engine 220 may also recommend actions or provide suggestions to the user at each stage of the method 222 based on the recorded ethics. For example, if the user indicates that a change was made (e.g., an action was performed on the data set) due to an ethical reason, the user may be provided with other actions that may be performed for the same or similar reason. This type of information and relationships is stored in the ethics database 218. In addition to recommending ethics-driven manipulations to a user, ethics-driven labels may also be recommended to the user when labels are added 208 to the manipulations.

The ethics engine 220 may include a control plane (e.g., a database such as the ethics database 218) that can store user provided ethics labels and orders of the manipulations. The ethics engine 220 is configured to prompt a user to provide the ethical reasons for the user's behavior, analyze individual values, analyze organizational ethics labels, and provide a feedback loop to suggest manipulations based on ethics labels. This information may be provided via any user interface of choice.

The ethics database 218 may include a plurality of tables or other structures. The tables may include a table that includes user entered ethics labels, decisions, and/or manipulations. Another table may include a set of ethics values. Another table may include a list of contexts, which indicates the type of activities that were in process when decisions were being made. More generally, the ethics database 218 may be arranged in many different manners.

The ethics database 218 is configured to store and track relationships in the context of the method 222 in one example. Thus, manipulations performed by users on a data set are tracked both from a user perspective and an organizational perspective. Labels generated by users, the reasons for the labels, the manipulations associated with the reasons, and the like may be stored in the ethics database 218.

By storing this type of information, the ethics engine 220 can ensure that manipulations including ethics-driven decisions can be recorded as a user interacts with a data set. In addition, the ethics database 218 can be used to provide recommendations to the user. For example, a user may perform an action based on an ethical reason. This will be recorded in the ethics database 218. At the same time, based on the ethical reason or associated label, the ethics engine 220 can recommend additional manipulations to the user. The manipulations may be associated with the same label or ethical reason identified by the user.

Embodiments of the invention create organizational ethics as a data set interaction variable. Users can be prompted to record an ethics reason during manipulations and metadata can be created to label data, manipulations, organizations, and individuals for use in making future manipulation recommendations including ethics-driven decisions. Secondary recommendations can be generated using the ethics labels. The use of existing ethics values can be used to suggest behaviors to other organizations or individuals of a similar type.

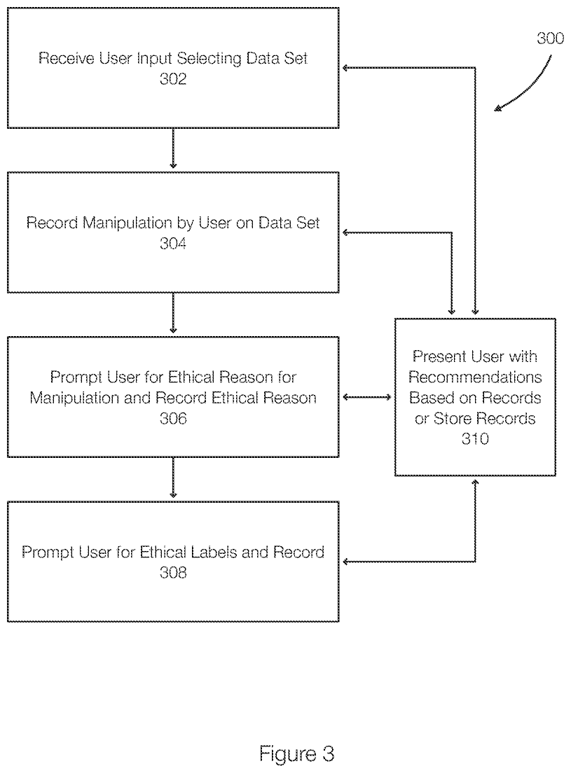

FIG. 3 illustrates an example of a method for ethics-driven data set utilization. In the method 300, user input is received to select 302 a data set. Manipulations performed on the data set are recorded 304. If the data set is already associated with ethics labels, the user may be presented 310 with recommendations that are based on the manipulations performed by the user or by other users. The recommendations can be generated from the ethics database. This relies on the labels/reasons between actions performed on a data set and ethical reasons for performing the actions. At the same time, the manipulations are recorded 310 and may be used for future recommendations.

Next, the user may be prompted 306 to provide ethical reasons for the manipulations that were performed. These ethical reasons are recorded for the user, the data set, the organization, or the like. The user may also be presented with recommended reasons. Other users, for example, may have recorded reasons and the user may be given the opportunity to use the same reasons or generate new reasons.

The user may next be prompted 308 for ethical labels to be associated with the manipulations, data set, user, and/or organization, which are recorded in the ethics database. The user may also receive recommendations for labels 310 based on relationships present in the ethics database. The labels may be different from the reason and may be attributes that were considered when deciding to perform a specific manipulation.

For example, a user may perform a manipulation to delete birth dates (DOB) from a data set. The reason provided by the user may be to protect the privacy interests of the individuals represented in the data set. This reason is based on an ethical concern of protecting privacy. Another reason is to comply with regulations. The labels provided by the user, which are related to an ethical reason, may include “date of birth” and “privacy”. All of these relationships may be recorded or stored in the ethics database 218 (or with the data sets themselves). Another user that accesses the same data set may indicate a desire to protect privacy. The ethics engine may then recommend to delete birth dates.

The ethics engine may also recommend additional manipulations. If the date birth was deleted due to an ethical reason of privacy, the ethics engine may determine that other users or organizations may have also performed manipulations such as deleting ethnicity or gender based on previously stored or recorded metadata. This allows the ethics engine to recommend these same manipulations to the user.

When prompting the user to provide labels or tags, the ethics engine may recommend, in addition to privacy, to include a label such as gender.

Embodiments of the invention provide an automated data set analysis and record keeping mechanism for ethics related data/metadata as data sets are used or created. Embodiments of the invention allow ethics to perform manipulations that are driven by or that account for ethics.

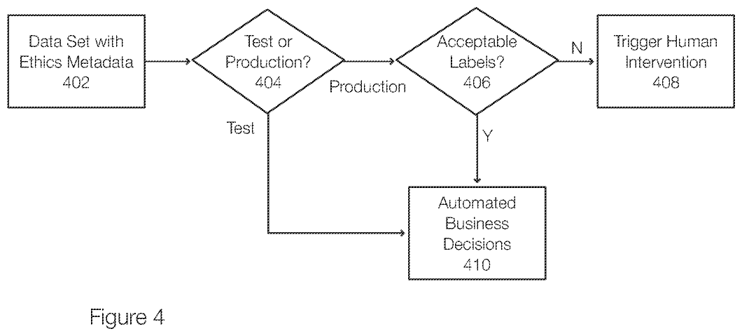

FIG. 4 discloses aspects of using ethics records or ethics metadata. In FIG. 4, a data set that is associated with ethics metadata (e.g., labels or tags) is selected 402. Next, a determination is made regarding whether the data set is used for production (Production at 404) or for testing (Test at 404).

If the data set is for production, the labels are evaluated 406 to determine if the labels are acceptable. More specifically, an organization or user may have a set of minimum ethics labels that are required and if the labels do not meet (No at 406) the minimum requirements, human intervention 408 may be triggered. In one example, the minimum requirements may depend on existing regulations. For example, certain HIPAA (Health Insurance Portability and Accountability Act) regulations may require the removal of patient identification information such as date of birth. This may allow ethic labels to be suggested or included based on regulations. In fact, the reason identified by a user may be regulations. Otherwise (Yes at 406), the data set is deemed useful for automated decisions (e.g., business decisions) 410. If the data is for test, automated decisions 410 may be tested.

An example workflow may proceed as follows. A user (e.g., a data scientist) may access a data set. In a brownfield environment, a proactive check for the user's common ethics labels is performed by the ethics engine by accessing the ethic database. The user's manipulations on this data set with matching labels is also determined by the ethics engine. This allows a set of manipulations to be supplied to the user as options. If the user takes or performs any of these manipulations, a record is created and stored.

Next, the user may perform a manipulation by modifying the data set to accommodate specific training needs or to accommodate a specific use case. For any such modification, the user is prompted to select a reason. If the change is made for ethical reasons, the user may be prompted to select an existing ethics label or add a new label. The reason, the action, and/or the labels are stored.

In a brownfield environment, another check may be performed for any manipulations that are based on the newly selected label. The manipulations may be provided as options to the user.

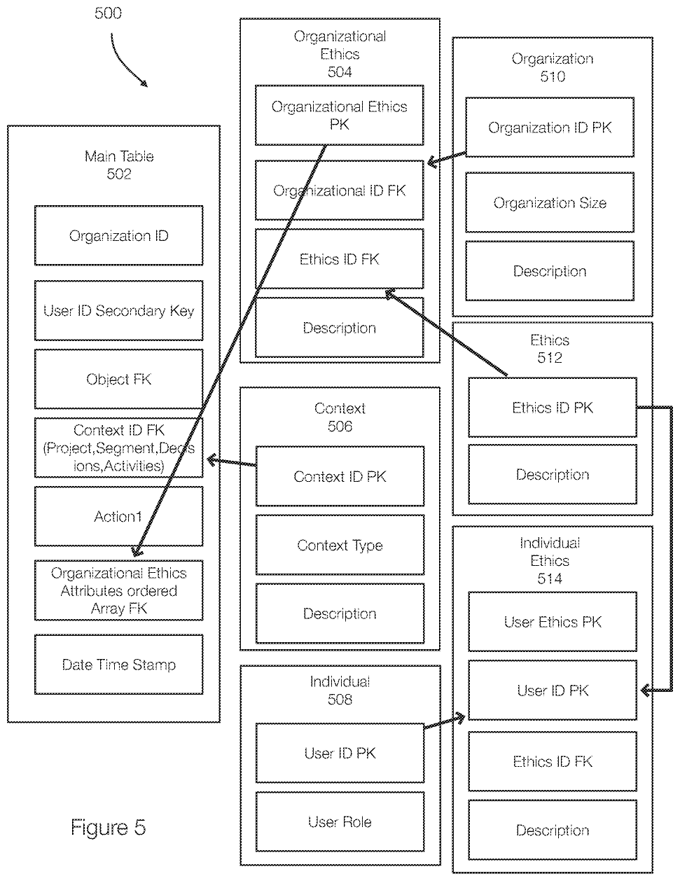

FIG. 5 discloses an example of an ethics database. The database 500, an example of the ethics database 218 and the metadata 108, may include various tables that may be related. For example, a main table 502 may be used to record manipulations taken by a user or an organization on a data set. Thus, the manipulation (e.g., action 1) is associated with an organization, organizational ethics, and the like. The organization ethics table 504 may store a description of various organizational ethics. The context table 506 may store a description and related metadata regarding a context in which actions were taken and/or recommended. The individual table 508 may contain information related to a user. The organization table 510 stores information about the organization. The ethics table 512 may store descriptions regarding ethics. The individual ethics table 514 may include a description of user ethics. As illustrated, the tables in the database 500 can be linked and are related.

Example links are illustrated, but the database is not limited thereto. In particular, an individual table 508 is linked to the individual ethics table 514. The context table 506 may be related to the main table 502. The organization ethics table 504 is related to an organization table 510 and an ethics table 512.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data set or data related operations including ethics based operations, ethics-driven operations, ethic based recommendations, or the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating data. As such, a particular client may employ, or otherwise be associated with, one or more instances of each of one or more applications that perform such operations with respect to data. Such clients may comprise physical machines, virtual machines (VM), or containers.

Particularly, devices in the operating environment may take the form of software, physical machines, or VMs, or any combination of these, though no particular device implementation or configuration is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: performing a manipulation on a data set in response to input from a user, prompting the user to determine whether the manipulation was performed for an ethical reason, recording the ethical reason and the manipulation in an ethics database, prompting the user for an ethics label related to the manipulation and the ethical reason, and recording the ethics label in the ethics database.

Embodiment 2. The method of embodiment 1, wherein the manipulation is one of searching for the data set, accessing the data set, or performing an action on the data set.

Embodiment 3. The method of embodiment 1 and/or 2, further comprising searching the ethics database based on the ethical reason for the manipulation.

Embodiment 4. The method of embodiment 1, 2, and/or 3, further comprising generating recommendations to the user for additional manipulations based on relationships to the ethical reason in the ethics database.

Embodiment 5. The method of embodiment 1, 2, 3, and/or 4, wherein the ethics database includes a plurality of related tables.

Embodiment 6. The method of embodiment 1, 2, 3, 4, and/or 5, wherein the tables include tables for organizations, tables for ethics of the organizations, tables for users, tables for ethics of the users, tables for manipulations and orders of manipulations.

Embodiment 7. The method of embodiment 1, 2, 3, 4, 5, and/or 6, further comprising storing metadata related to ethical manipulations initiated by a user using an ethics engine.

Embodiment 8. The method of embodiment 1, 2, 3, 4, 5, 6, and/or 7, further comprising generating recommended manipulations based on ethical metadata stored in the ethics database using the ethics engine.

Embodiment 9. The method of embodiment 1, 2, 3, 4, 5, 6, 7, and/or 8, further comprising suggesting manipulations to other individuals or users.

Embodiment 10. The method of embodiment 1, 2, 3, 4, 5, 6, 7, 8, and/or 9, further comprising relating the ethical reason and/or the ethics label to the data set, the user, the manipulation, and/or an organization.

Embodiment 11. A method for performing any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

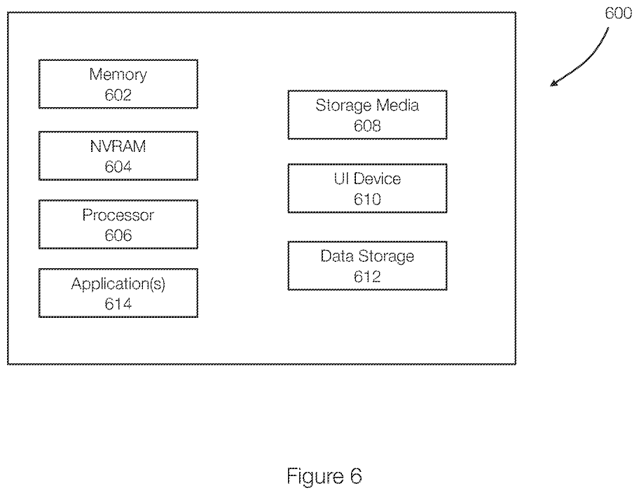

With reference briefly now to FIG. 6, any one or more of the entities disclosed, or implied, by the Figures, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
performing a manipulation on a data set in response to input from a user;
prompting the user to determine whether the manipulation was performed for an ethical reason;
recording the ethical reason and the manipulation in an ethics database;
prompting the user for an ethics label related to the manipulation and the ethical reason; and
recording the ethics label in the ethics database.

2. The method of claim 1, wherein the manipulation is one of searching for the data set, accessing the data set, or performing an action on the data set.

3. The method of claim 1, further comprising searching the ethics database based on the ethical reason for the manipulation.

4. The method of claim 3, further comprising generating recommendations to the user for additional manipulations based on relationships to the ethical reason in the ethics database.

5. The method of claim 1, wherein the ethics database includes a plurality of related tables.

6. The method of claim 5, wherein the tables include tables for organizations, tables for ethics of the organizations, tables for users, tables for ethics of the users, tables for manipulations and orders of manipulations.

7. The method of claim 1, further comprising storing metadata related to ethical manipulations initiated by a user using an ethics engine.

8. The method of claim 7, further comprising generating recommended manipulations based on ethical metadata stored in the ethics database using the ethics engine.

9. The method of claim 1, further comprising suggesting manipulations to other individuals or users.

10. The method of claim 1, further comprising relating the ethical reason and/or the ethics label to the data set, the user, the manipulation, and/or an organization.

11. A non-transitory storage medium having stored therein instructions that are executable by one or more hardware processors to perform operations comprising:
performing a manipulation on a data set in response to input from a user;
prompting the user to determine whether the manipulation was performed for an ethical reason;
recording the ethical reason and the manipulation in an ethics database;
prompting the user for an ethics label related to the manipulation and the ethical reason; and
recording the ethics label in the ethics database.

12. The non-transitory storage medium of claim 11, wherein the manipulation is one of searching for the data set, accessing the data set, or performing an action on the data set.

13. The non-transitory storage medium of claim 11, further comprising searching the ethics database based on the ethical reason for the manipulation.

14. The non-transitory storage medium of claim 13, further comprising generating recommendations to the user for additional manipulations based on relationships to the ethical reason in the ethics database.

15. The non-transitory storage medium of claim 11, wherein the ethics database includes a plurality of related tables.

16. The non-transitory storage medium of claim 15, wherein the tables include tables for organizations, tables for ethics of the organizations, tables for users, tables for ethics of the users, tables for manipulations and orders of manipulations.

17. The non-transitory storage medium of claim 11, further comprising storing metadata related to ethical manipulations initiated by a user using an ethics engine.

18. The non-transitory storage medium of claim 17, further comprising generating recommended manipulations based on ethical metadata stored in the ethics database using the ethics engine.

19. The non-transitory storage medium of claim 11, further comprising suggesting manipulations to other individuals or users.

20. The non-transitory storage medium of claim 11, further comprising relating the ethical reason and/or the ethics label to the data set, the user, the manipulation, and/or an organization.
